(19) United States
(12) Patent Application Publication
(10) Pub. No.: US 2024/0343993 A1
(43) Pub. Date: Oct. 17, 2024

(54) Fragrance or Aroma Compositions Accepted or Preferred by Pets

(71) Applicant: Symrise AG, Holzminden (DE)

(72) Inventors: Katharine Prigge, West Caldwell, NJ (US); Laura Meunier, Einbeck (DE); Cécile Petel, Hennebon (FR); Marco Singer, Colombes (FR); Keith McDermott, Bound Brook, NJ (US)

(21) Appl. No.: 18/577,496

(22) PCT Filed: Dec. 21, 2021
(86) PCT No.: PCT/EP2021/087007

§ 371 Date: Jan. 8, 2024

Related U.S. Application Data
(60) Provisional application No. 63/230,565, filed on Aug. 6, 2021.

(51) Int. Cl. C11B 9/00; A01K 1/01; A01K 1/015; A01K 1/035; A01K 13/00; A01K 15/02

(52) U.S. Cl. CPC C11B 9/0061; C11B 9/0019; C11B 9/0038; C11B 9/0046; C11B 9/0076; C11B 9/008; C11B 9/0084; C11B 9/0092; A01K 1/0107; A01K 1/0157; A01K 1/0353; A01K 13/00; A01K 15/025

(57) ABSTRACT

The present invention relates to novel fragrance or aroma/flavour compositions, that are accepted or preferred by pets, in particular pet fragrance or pet aroma/flavour compositions. The invention also relates to the use of such fragrance or aroma/flavour compositions for preparing a perfumed or flavored product, in particular a perfumed or flavored pet product that is pet accepted or pet preferred. Furthermore, the invention relates to perfumed products or flavored product comprising the fragrance or aroma/flavour composition. Finally, the present invention pertains to a method for scenting a pet, a product or a room by applying the fragrance composition or perfumed product.

### FIELD OF THE INVENTION

The present invention relates to novel fragrance or aroma/flavour compositions, that are accepted or preferred by pets, in particular pet fragrance or pet aroma/flavour compositions. The invention also relates to the use of such fragrance or aroma/flavour compositions for preparing a perfumed or flavored product, in particular a perfumed or flavored pet product that is pet accepted or pet preferred. Furthermore, the invention relates to perfumed products or flavored product comprising the fragrance or aroma/flavour composition. Finally, the present invention pertains to a method for scenting a pet, a product or a room by applying the fragrance composition or perfumed product.

### STATE OF THE ART

With the improvement of people's living standards and the acceleration of social urbanization, pets are increasingly becoming part of the family, and therefore are routinely exposed to consumer fragrances. Acceptance of the scent of a product is a major driver of overall product acceptance. To date, most homecare products are focused with the consumer acceptance in mind. Products are extensively tested and optimized for fragrance and properties found most pleasing to humans. However, up to now, there is no focus on fragrance and product acceptance by the pets themselves. Humans have 15 million olfactive neurons, cats 67 million and dogs 200 million. It is known that there are differences in our pet's ability to smell, yet we have no understanding of how they respond to fragrance in typical consumer products.

A scent cats find unpleasant in cat litter leads to negative elimination behaviour, such as refusal or outright rejection of the litter box, often indicated by undesired waste dropping elsewhere in the household. House soiling is the most common behavioural problem reported by cat owners, and often undermines the bond between pet and owner. A leading cause of this negative behaviour is litter box aversion, which can be driven by a scented litter cats find unpleasant.

WO 2016/170475 A1 discloses the use of L-Feline (2-maino-7-hydroxy-5,5-dimethyl-4-thiaheptanoic acid) for attracting a cat to eliminate in a litter box. According to the disclosure thereof, 21 commercial cat attractants, including L-Feline, were tested as to evaluate the preference of the cats to eliminate urine and faeces in a litter versus a control. Only L-Feline was significantly preferred by cats for urine elimination.

WO 2019/145557 A1 concerns a pet litter comprising a composition comprising 2,2-dimethyl-1,3-dioxolane-4-methanol.

Hence, there is sustained interest within the fragrance or aroma/flavour industry in developing new fragrance or aroma substances that attract pets, in particular cats and dogs. There is a further need for consumer products to be well accepted by pets who share the same environment in the home as their human owners, as their safely and well-being is highly dependent on it.

The object of the present invention is thus to provide a fragrance or aroma/flavour composition, in particular a pet fragrance or aroma/flavour composition, that is accepted and not rejected by the pets. Another object of the present invention is the provision of consumer products or pet products that are organoleptic, i.e. by their smell or taste, accepted by the pets.

The present invention demonstrates that specific fragrance or aroma/flavour compositions are accepted and not rejected by pets.

The invention is based on the surprising finding, that fragrance directions having at least one compound or a lead sensory component with a preferably gourmand odor type impression or having at least one compound or a lead sensory component with a preferably musk odor type impression are well accepted by both, cats and dogs, but that fragrance directions having at least one compound or a lead sensory component with a preferably woody odor type impression are repulsive materials and thus, are less accepted by both, cats and dogs.

### SUMMARY OF THE INVENTION

In a first aspect, the present invention relates to a fragrance or an aroma/flavour composition, in particular a pet fragrance composition or pet aroma/flavour composition comprising or consisting of at least one compound or lead sensory component of
group (A) consisting of compounds with a preferably gourmand odor type impression, wherein the compounds are selected from the group consisting of
vanillin (4-hydroxy-3-methoxybenzaldehyde),
ethyl vanillin (3-ethoxy-4-hydroxybenzaldehyde),
ethyl maltol (2-ethyl-3-hydroxy-4H-pyran-4-one),
coumarin (2H-1-benzopyran-2-one),
Tonkalactone® (3,6-dimethyl-3H-1-benzofuran-2-one),
Frambinon® (4-(p-methoxyphenyl)-2-butanone),
benzaldehyde,
ethyl-2-methyl butyrate,
2-methoxy-3-ethyl pyrazine,
delta-decalactone, delta-nonalactone, gamma-octalactone,
and mixtures thereof,
and/or
group (B) consisting of compounds with a preferably musk odor type impression, wherein the compounds are selected from the group consisting of
aldron (4-[(6,6-dimethyl-5-bicyclo[2.2.1]heptanyl)methyl]-2-methylcyclohexan-1-one),
lactoscatone ((2R,4aR,8aS)-2,8,8-trimethyloctahydro-2H-4a,2-(epoxymethano)naphthalen-10-one),
ambrettolide (17-oxacycloheptadec-6-en-1-one),
ethylene brassylate (1,4-dioxacycloheptadecane-5,17-dione),
Globalide® ((3E)-oxacyclohexadec-3-en-2-one),
globanone ((8E)-cyclohexadec-8-en-1-one),
and mixtures thereof.

In a second aspect, the present invention relates to the use of the fragrance composition or aroma/flavour composition, in particular the pet fragrance composition or the pet aroma/flavour composition for preparing a perfumed or flavored product, preferably a perfumed or flavored pet product.

In a third aspect, the present invention relates to a perfumed product, such as personal or home care products, surface care products, cleaning products, air care products, fabric products, auto care products, pet care products etc., or a flavored product, such as treats, breath and oral care products for pets, or edible pet products etc., comprising the fragrance or aroma/flavour composition according to the present invention, in an effective amount.

In a final aspect, the present invention pertains to a method for scenting a pet, a product or a room, comprising the steps of
(i) providing a fragrance composition according to the present invention or a perfumed product according to the present invention; and
(ii) applying the fragrance composition or perfumed product in a sensory effective amount to the pet, the product or the room to obtain an odor accepted by pets.

Further aspects of the invention emerge from the following description, examples and attached patent claims.

### FIGURES

FIG. 1 is a diagram showing exemplary the mean deposits weight per condition for a rejected fragrance (jasmin accord).

FIG. 2 is a diagram showing exemplary the mean deposits weight per condition for an accepted fragrance (musk accord).

FIG. 3 represents a histogram showing the significancy of weight results in cat litter for jasmin accord and musk accord in comparison.

FIG. 4 is a diagram showing the refusal ratio for vanillin and jasmin accord in a dog evaluation.

FIG. 5 is a diagram with an overview of cat hedonic results summarizing accepted and non-accepted fragrances/accords.

FIG. 6 is an overview of dog hedonic results summarizing accepted fragrances/accords.

### DETAILED DESCRIPTION OF THE INVENTION

Within the context of the present invention, a fragrance composition in general is a composition comprising an individual chemical compound or a class of two or more different chemical compounds to impart an odour or smell.

Within the context of the present invention, an aroma/flavour composition in general is a composition comprising an individual chemical compound or class of two or more different chemical compounds to impart a flavour or a taste.

Flavours affect both the sense of taste and smell, whereas fragrances affect only smell.

The composition according to the present invention can be both, either a fragrance composition or an aroma/flavour composition.

Additionally, in the context of the present invention, the terms “aroma” or “flavour” are used interchangeable and in an equivalent sense.

Whenever reference is made in the description to the fragrance composition or aroma/flavour composition according to the present invention, this is deemed to refer also to the pet fragrance composition or pet aroma/flavour composition according to the present invention.

Within the context of the present invention, the term “effective amount” refers to the amount of the of at least one compound or lead sensory component which is needed or is sufficient to create the desired response in a pet, namely the amount to impart a perceptible odour or flavour in the fragrance or aroma/flavour composition or in the final product, incorporated therein. When applied to a combination of flavour or fragrance substances, the term refers to the total amount of the combination of flavour or fragrance substances resulting in the flavour or odour. Most importantly, the user must be able to perceive the odor or taste when administering the fragrance composition or flavour composition according to its typical usage instructions.

The term “comprising” means that the named components are essential, but other components may be added and is still embraced by the present invention.

The term “consisting of” as used according to the present invention means that the total amount of components adds up to 100% by weight, based on the total weight of the composition, and signifies that the subject matter is closed-ended and can only include the limitations that are expressly recited.

Whenever reference is made to “comprising” it is intended to cover both meanings as alternatives, that is the meaning can be either “comprising” or “consisting of”, unless the context dictates otherwise.

The term “at least one compound or lead sensory component” means that the composition according to the present invention can comprise either one component or lead sensory component or a mixture of two, three, or even more different compounds or lead sensory components.

The terms “compound” or “lead sensory component” in the context of the present invention means a compound or component having a particular sensory effect, for example a gourmand note or a musk note or a woody note, which is the leading component in the fragrance composition or aroma/flavour composition according to the present invention and having the most important impact on the olfactory or gustatory effect on the fragrance or aroma/flavour composition. For example, if the lead sensory component is a compound with a preferably gourmand odor type note, the resulting composition will be dominated by a gourmand odor type impression. If the lead sensory component is a compound with a preferably musk odor type note, the resulting composition will be dominated by a musk odor type impression, etc.

The term “optionally” means that the subsequently described compound may but need not to be present in the composition, and that the description includes variants, where the compound is included or variants, where the compound is absent.

In accordance with the present invention, the above object is achieved by a fragrance or an aroma/flavour composition, preferably a pet fragrance or a pet aroma/flavour composition, comprising or consisting of a sensory effective amount of at least one compound or lead sensory component of group (A) consisting of compounds with a preferably gourmand odor type impression, wherein the compounds are selected from the group consisting of
vanillin (4-hydroxy-3-methoxybenzaldehyde),
ethyl vanillin (3-ethoxy-4-hydroxybenzaldehyde),
ethyl maltol (2-ethyl-3-hydroxy-4H-pyran-4-one),
coumarin (2H-1-benzopyran-2-one),
Tonkalactone® (3,6-dimethyl-3H-1-benzofuran-2-one),
Frambinon® (4-(p-methoxyphenyl)-2-butanone),
benzaldehyde,
ethyl-2-methyl butyrate,
2-methoxy-3-ethyl pyrazine,
delta-decalactone, delta-nonalactone, gamma-octalactone,
   and mixtures of two, three or even more of the afore-mentioned compounds.

In a preferred variant, the fragrance or aroma/flavour composition according to the present invention comprises or consists of a compound or lead sensory component of group (A) selected from the group consisting of
vanillin (4-hydroxy-3-methoxybenzaldehyde),
Tonkalactone® (3,6-dimethyl-3H-1-benzofuran-2-one),
   and a mixture of the two afore-mentioned compounds.

In a preferred variant, the fragrance composition or aroma/flavour composition according to the present invention comprises vanillin and Tonkalactone®.

The compounds with a preferably gourmand odor type impression are characterized by an edible odor/smell or flavour/taste, including but not limited to vanilla, sweet, whipped or caramelized sugar, honey, chocolate, caramel, almond, coconut, creamy, minty, cinnamon and/or nutty odor/smell or flavour/taste impressions.

The compound or lead sensory component specified above can either be used as individual substance or in mixtures with at least one other (in the following designated as accords).

In a preferred variant according to the present invention, the fragrance or the aroma/flavour composition according to the present invention thus comprises a sensory effective of more than at least one, i.e. a mixture of two, three or even more, of the compounds or lead sensory components of group (A) consisting of compounds with a preferably gourmand odor type note.

Preferred fragrance/accord compositions with a gourmand odor type note according to the present invention are for example those comprising one, two, three or even more compound(s) or lead sensory component(s) of group (A), as specified in the following Table 1:

TABLE 1

| Composition | Raw material |
|---|---|
| 1 | Vanillin |
| | Vanillin |
| 2 | Methoxy ethyl pyrazine |
| | Methoxy ethyl pyrazine |
| 3 | Vanilla accord |
| | Ethyl maltol |
| | Heliotropin |
| | Vanillin |
| 4 | Tonkalactone accord |
| | Furaminton/Tonkalactone ® |
| | (10% DPG) |
| | Vanillin (10% DPG) |
| 5 | Coconut accord |
| | Vanillin (10% DPG) |
| | Decalactone delta |
| | Nonalactone delta |
| | Octalactone gamma |
| 6 | Berry accord |
| | Ethyl methylphenylglycidate |
| | Ethyl maltol |
| | Frambinon ® |
| | Ethyl methyl butyrate-2 |
| 7 | Red fruit accord |
| | Aldehyde C16 |
| | Ethyl maltol (10% DPG) |
| | Ethyl isobutyrate |
| | Frambinon ® (10% DPG) |
| | Ethyl methyl butylrate-2 |

As can be seen from the exemplary compositions of Table 1, the fragrance composition or aroma/flavour composition comprises either a single compound or lead sensory component as defined above or the fragrance composition or aroma/flavour composition is an accord of two or more different compounds or lead sensory components as defined above.

Alternatively, the above object is achieved by a fragrance or an aroma/flavour composition, preferably a pet fragrance or a pet aroma/flavour composition comprising or consisting of a sensory effective amount of at least one compound or lead sensory component of group (B) consisting of compounds with a preferably musk odor type impression, wherein the compounds are selected from the group consisting of
aldron (4-[(6,6-dimethyl-5-bicyclo[2.2.1]heptanyl)methyl]-2-methylcyclohexan-1-one),
lactoscatone ((2R,4aR,8aS)-2,8,8-trimethyloctahydro-2H-4a,2-(epoxymethano)naphthalen-10-one),
ambrettolide (17-oxacycloheptadec-6-en-1-one),
ethylene brassylate (1,4-dioxacycloheptadecane-5,17-dione),
Globalide® ((3E)-oxacyclohexadec-3-en-2-one),
globanone ((8E)-cyclohexadec-8-en-1-one),
   and mixtures of two, three or even more of the afore-mentioned compounds.

In a preferred variant, the fragrance or aroma/flavour composition according to the present invention comprises or consists of a compound or lead sensory component of group (B) selected from the group consisting of
ambrettolide (17-oxacycloheptadec-6-en-1-one),
Globalide® ((3E)-oxacyclohexadec-3-en-2-one),
globanone ((8E)-cyclohexadec-8-en-1-one),
   and mixtures of two or three afore-mentioned compounds.

Particularly preferred is a mixture/combination of compounds or lead sensory components selected from the group consisting of:
ambrettolide and Globalide®, or
ambrettolide and globanone, or
Globalide® and globanone, or
ambrettolide and Globalide® and globanone.

The compounds with a preferably musk odor type impression are characterized by a musky odor/smell, most typically described as animalic, but also range from sweet, creamy or powdery, to rich, leathery, spicy odor/smell or flavour/taste impressions.

The compound or lead sensory component specified above can either be used as individual substance or in mixtures with at least one other (in the following designated as accords).

In a preferred variant according to the present invention, the fragrance or the aroma/flavour composition according to the present invention thus comprises a sensory effective of more than at least one, i.e. a mixture of two, three or even more, of the compounds or lead sensory components of group (B) consisting of compounds with a preferably musk odor type note.

Preferred fragrance/accord compositions with a musk odor type note according to the present invention are for example those, comprising one, two, three or even more compound(s) or lead sensory component(s) of group (B), as specified in the following Table 2:

TABLE 2

| Composition | Raw material |
|---|---|
| 1 | Aldron |
| | Aldron |
| 2 | Lactoscatone |
| | Lactoscatone |
| 3 | Ambrettolide |
| | Ambrettolide |
| 4 | Musk accord |
| | Globalide |
| | Ethylene brassylate |
| 5 | Globanone |
| | Globanone |

As can be seen from the exemplary compositions of Table 2, the fragrance composition or aroma/flavour composition comprises either a single compound or lead sensory component as defined above or the fragrance composition or aroma/flavour composition is an accord of two or more different compounds or lead sensory components as defined above.

In a further variant, the fragrance or the aroma/flavour composition, preferably the pet fragrance or a pet aroma/flavour composition, according to the present invention comprises a sensory effective amount of at least one compound or lead sensory component of group (A) consisting of compounds with a preferably gourmand odor type impression, as specified above, and a sensory effective amount of at least one compound or lead sensory component of group (B) consisting of compounds with a preferably musk odor type impression, as specified above.

In a preferred variant according to the present invention, the fragrance or the aroma/flavour composition according to the present invention comprises a mixture of two, three or even more of the compounds or lead sensory components of group (A) consisting of compounds with a preferably gourmand odor type note and two, three or even more of the compounds or lead sensory components of group (B) consisting of compounds with a preferably musk odor type note.

In a more preferred variant the fragrance or aroma/flavour composition according to the present invention comprises or consists of a compound or lead sensory component selected from the group consisting of
Tonkalactone® (3,6-dimethyl-3H-1-benzofuran-2-one),
vanillin (4-hydroxy-3-methoxybenzaldehyde),
Globalide® ((3E)-oxacyclohexadec-3-en-2-one),
ethylene brassylate (1,4-dioxacycloheptadecane-5,17-dione),
   and mixtures of two or even more of the afore-mentioned compounds.

Particularly preferred is a mixture of compounds or lead sensory components selected from the group consisting of:
Tonkalactone® and vanillin; or
Tonkalactone® and Globalide®; or
Tonkalactone® and ethylene brassylate; or
vanillin and Globalide®; or
vanillin and ethylene brassylate; or
Globalide® and ethylene brassylate; or
Tonkalactone® and vanillin and Globalide®; or
Tonkalactone® and vanillin and ethylene brassylate; or
Vanillin and Globalide® and ethylene brassylate.

Surprisingly, it turned out that fragrance or aroma/flavour directions specified above are well attractive to both cats and dogs, while at the same time pleasant to humans, as it is demonstrated by the experimental data in the following examples by measurement of behavioral parameters. Additionally, it was unexpected observed that the fragrance composition or aroma/flavour composition according to the present invention was advantageously able to attract pets, preferably cats or dogs.

Likewise, it turned out that specific fragrance or aroma/flavour directions having a woody odor type impression are repulsive fragrances, that are rejected by both cats and dogs as it is demonstrated by the experimental data in the following examples by measurement of behavioral parameters.

In a further and particularly preferred variant, the present invention therefore relates to a fragrance or aroma/flavour composition, preferably a pet fragrance or aroma/flavour composition, that does not include at least one compound or lead sensory component of group (C) consisting of compounds with a preferably woody odor type impression. Such repulsive materials are selected form the group consisting of cedar leaf oil, blonde woods, bleach accord, jasmin accord, orange flower and mixtures thereof.

Hence, in a preferred variant, the fragrance or aroma/flavour composition, preferably the pet fragrance or aroma/flavour composition, according to the present invention does not comprise any of the compound or lead sensory component of group (C) as defined before.

Fragrance/accord compositions with a woody odor type impression according to the present invention are for example those, as specified in the following Table 3:

TABLE 3

| Composition | Raw material |
|---|---|
| 1 | Cedar leaf oil |
| | Cedar leaf oil |
| 2 | Blonde woods |
| | Amberwood ® F |
| | Cedarwood oil |
| | Iso E super |
| | Sandranol ® |
| 3 | Jasmin accord |
| | Benzyl acetate |
| | Dihydro jasmone |
| | Hedione |
| | Hexyl cinnamic |
| | aldehyde alpha |
| | Indole |

In the fragrance composition or aroma/flavour compositions according to the first aspect of the present invention, the amount of the at least one compound or lead sensory component of group A and/or the at least one compound or lead sensory component of group B used is preferably in a range of 1 to 100% by weight, preferably in a range of 5 to 90% by weight, more preferred in a range of 10 to 80% by weight, still more preferred in a range of 20 to 70% by weight, particularly preferred in a range of 30 to 60% by weight, most preferred in a range of 40 to 50% by weight, relative to the total weight of the composition. If the fragrance composition or aroma/flavour composition comprises a blend of said compounds or lead sensory components, the above weight specification are related to the blend.

In a still further and preferred variant, the fragrance or aroma/flavour composition, preferably the pet fragrance composition or pet aroma/flavour composition, according to the first aspect of the present invention further comprises one or more additional fragrance substances with a preferably floral odor type impression. Such additional fragrance substances with a preferably floral odor type impression are selected from the group consisting of methyl octine carbonate (methyl-non-2-ynoate), phenyl ethyl alcohol (2-phenylethan-1-ol), citronellol (3,7-dimethyloct-6-en-1-ol), lavender oil, peppermint oil and mixtures of two or even more of the afore-mentioned compounds.

Lavender essential oil is produced through steam distillation. The exact composition of lavender essential oil varies from species to species but consists primarily of monoterpeneoids and sesquiterpeneoids components. Of these components or lead sensory components, linalool and linalyl acetate dominate, with moderate levels of lavandulyl acetate, terpinene-4-ol and lavandulol. 1,3-cineole and camphor are also present in low to moderate qualities. Peppermint oil is composed primarily of menthol and menthone as lead sensory components as well as several other minor constituents, including menthofuran, 1,8-cineole, and limonene.

In a still further and preferred variant, the fragrance or aroma/flavour composition, preferably the pet fragrance composition or pet aroma/flavour composition, according to the first aspect of the present invention further comprises one or more additional fragrance substances with a preferably citrus odor type impression. Such additional fragrance substances with a preferably citrus odor type impression are selected from the group consisting of orange oil, Litsea cubeba oil, mandarin aldehyde (trans-2-dodecenal), agrunitril (3,7-dimethyloct-6-enenitrile), citral (3,7-dimethyl-2,6-octadienal), and mixtures of two or even more of the afore-mentioned compounds.

The present invention is dedicated to pets. Preferably, the pet is a mammal. In the context of the present invention, dogs and cats are preferred.

The fragrance or aroma/flavour composition, preferably the pet fragrance composition or pet aroma/flavour composition, according to the first aspect of the present invention are characterized by a high acceptance by pets, preferably by cats and/or dogs.

The fragrance composition or aroma/flavour composition according to the present invention may be used for perfuming or flavouring. The fragrance composition or aroma/flavour composition as defined herein, can be used either as such or alternatively in liquid form, i.e. a solution, undiluted or diluted with a solvent.

Solvents suitable for this purpose are for example ethanol, isopropanol, diethylene glycol monoethyl ether, glycerol, propylene glycol, 1,2-butylene glycol, dipropylene glycol, diethyl phthalate, triethyl citrate, isopropyl myristate, triacetin, vegetable oils, 2,2,4-trimethyl-1,3-pentanediol monoisobutyrate, tripropylene glycol methyl ether, dipropylene glycol monomethyl ether, dioctyl adipate 2,2-dimethyl-1,3-dioxolane-4-methanol, diisopropanolamine, silicones, isopropyl palmitate, isostearyl alcohol, and/or methyl hydrogenated rosinate, etc.

Moreover, the fragrance composition or aroma/flavour composition according to the invention may be adsorbed on a carrier which ensures both a fine distribution of the aroma/flavour or fragrance substances in the product and controlled release on use. Such carriers may be porous inorganic materials such as sodium sulphate, silica, zeolites, gypsums, clays, clay granules, aerated concrete etc., or organic materials such as woods, cellulose-based substances, sugars, dextrins (for example maltodextrin), or plastics such as PVC, polyvinyl acetates or polyurethanes, acrylates, synthetic fibers.

The fragrance composition or aroma/flavour composition according to the invention may also be spray-dried, be provided as inclusion complexes or as extrusion products or in microencapsulated form.

Spray-dried fragrance compositions or flavour compositions may be produced for example by spray-drying an emulsion or dispersion containing the flavour or fragrance composition, wherein modified starches, proteins, dextrin and vegetable gums may be used as carriers. Inclusion complexes may be produced for example by introducing dispersions of the flavour or fragrance substance composition and cyclodextrins or urea derivatives into a suitable solvent, for example water.

Extrusion products may be produced by melting the fragrance composition or flavour compositions with a suitable waxy substance and extruding with subsequent solidification, optionally in a suitable solvent, for example isopropanol.

Optionally, the properties of the compositions modified in this way may be further optimised with regard to a more targeted flavour or fragrance release by “coating” with suitable materials, for which purpose waxy plastics such as for example polyvinyl alcohol are preferably used.

The flavour or fragrance composition according to the invention may be encapsulated, for example, by coacervation methods with the assistance of capsule materials made for example from polyurethane-type substances or soft gelatine.

All of the above-described resultant product variants are fragrance compositions or aroma/flavour compositions according to the invention.

Due to its immanent beneficial gustatory and/or olfactory properties, accepted by pets, the fragrance composition or the flavour composition, preferably the pet fragrance composition or the pet flavour composition, according to the present invention is advantageous for preparing a perfumed or flavored product, preferably a perfumed or flavored pet product.

Another aspect of the present invention thus relates to the use of the fragrance composition or aroma/flavour composition as above described for preparing a perfumed or flavored product, preferably a perfumed or flavored pet product. With regard to the preferred variants of the fragrance compositions or aroma/flavour compositions according to the invention, the description made above of course apply correspondingly.

The fragrance composition according to the invention may be incorporated into products which are flavoured or perfumed or are intended to be flavoured or perfumed, preferably personal or home care products, surface care products, cleaning products, air care products, fabric products, auto care products, pet care grooming or oral care products, or edible pet products.

In accordance with a preferred development, the perfumed or flavoured products containing the fragrance composition or aroma/flavour composition according to the invention are produced by incorporating the fragrance composition or aroma/flavour composition without a solvent, as a solution or in the form of a mixture with a solid or liquid carrier and optionally other auxiliaries and/or stabilisers to form a base preparation for preparing personal or home care products, surface care products, cleaning products, air care products, fabric products, auto care products, pet care grooming or oral care products, or edible pet products.

The present invention therefore also provides in a further aspect perfumed products, preferably perfumed pet products, comprising the perfumed composition according to the present invention. Preferably, the perfumed product according to the present invention is selected from the group consisting of personal cosmetic, toiletry, and healthcare products such as dry and wet wipes, washes, baths, shampoos, gels, soaps, mousses, cleansing compositions, bath oils, other bath compositions that may be added to a bath, other wash compositions that may be used directly on the skin, leave-on personal care products include personal cosmetic, toiletry, and healthcare products such as sticks, balms, mousses, sprays, lotions, creams, gels, powders, oils, waxes, perfumes, other personal care compositions that may be applied to the skin and not rinsed off, or home or laundry care products such as fabric detergents, fabric softeners, linen sprays, air care products, candles, sprays, diffusers, devices or other products that may be used in the home for the purpose of cleaning surfaces, fabrics or perfuming the air as well as auto care products such as car air fresheners, wipes, cleaning agents, odor removers, foggers, vent clips, aerosols, fabric refresher sprays and pet products such as cat litters, cat litter boxes, cat toys, cat trees, dog toys, dog pads, dog beddings, and pet care grooming products such as pet shampoos, wipes, cleansers or conditioning products.

Further perfumed products according to the invention include for example perfume extracts, eaux de parfum, eaux de toilette, shaving lotions, eaux de cologne, pre-shave products, splash colognes and perfumed tissue wipes, including for perfuming acidic, alkaline and neutral cleaning agents such as for example floor cleaners, window cleaners, dishwashing detergents, bath and sanitary cleaners, scouring creams, solid and liquid toilet cleaners, pulverulent and foam carpet cleaners, textile fresheners, ironing aids, liquid detergents, pulverulent detergents, laundry pre-treatment agents such as bleaches, soaking agents and stain removers, laundry rinse conditioners, laundry soaps, laundry tablets, disinfectants, surface disinfectants as well as air fresheners in liquid or gel form or those applied to a solid carrier, aerosol sprays, waxes and polishes such as furniture polishes, floor waxes and shoe polishes as well as body care products such as for example solid and liquid soaps, shower gels, shampoos, shaving soaps, shaving foams, bath oils, cosmetic emulsions of the oil-in-water, water-in-oil and water-in-oil-in-water type such as for example skin creams and lotions, face creams and lotions, sunscreen creams and lotions, after-sun creams and lotions, hand creams and lotions, foot creams and lotions, depilatory creams and lotions, after-shave creams and lotions, tanning creams and lotions, hair care products such as for example hair sprays, hair gels, strengthening hair lotions, hair rinses, permanent and semi-permanent hair dyes, hair styling agents such as cold waving and hair straightening agents, hair tonics, hair creams and lotions, deodorants and antiperspirants such as for example underarm sprays, roll-ons, deodorant sticks, deodorant creams, decorative cosmetic products such as for example eyeshadow, nail varnish, make-up products, lipstick, mascara, as well as candles, lamp oils, incense sticks, insecticides, repellents and fuels or oral and/or dental care products such as toothpastes, tooth gels, tooth powders, mouthwashes, chewing gum and other oral care products.

The present invention also provides in another aspect flavoured products, preferably flavoured pet products, comprising the aroma/flavour composition according to the present invention. Preferably, the flavoured pet product according to the present invention is selected from the group consisting of edible pet products. Preferably, the flavored pet product according to the present invention is selected from the group consisting of treats, breath and oral care products.

Preferably, the fragrance composition or aroma/flavour composition, preferably the pet fragrance composition or pet aroma/flavour composition, according to the present invention is contained in an amount sufficient to impart a perceptible odour or flavour in the final product. Preferably, the fragrance composition or aroma/flavour composition is contained in a total amount in a range of 0.001% to 70% by weight, preferably in a total amount in a range of 0.01% to 60% by weight, more preferred in a total amount in a range of 0.1% to 50% by weight, based on the total weight of the perfumed or flavored product.

In a final aspect, the present invention pertains to a method for scenting a pet, a product or a room, comprising the steps of
(i) providing a fragrance composition according to the present invention or a perfumed product according to the present invention; and
(ii) applying the fragrance composition or perfumed product in a sensory effective amount to the pet, the product or the room to obtain an odor accepted by pets.

The present invention shall now be described in detail with reference to the following examples, which are merely illustrative of the present invention, such that the content of the present invention is not limited by or to the following examples.

### EXAMPLES

The following examples have the purpose of clarifying the invention, without limiting it thereby.

### Example 1—Acceptance or Rejection of Fragrance Compounds

### 1. Method:

### Cat Hedonics Testing:

Tests were performed in order to determine if fragrance compositions influenced cat elimination behavior.

Twenty cats living in 5 rooms (4 cats per room) were involved in the study. Two litter boxes containing two different products (i.e. an unscented cat litter control, non-clumping clay versus an experimental cat litter, non-clumping clay dosed with 0.01-0.5% of fragrance composition) were presented to the cats.

Diet was controlled for each test day by measuring food intake and keeping the food consistent for the duration of each test. The litter box was changed at the end of each day (24 h), weighed to determine weight deposits, and replenished with fresh litter for day 2 testing. The location of the two litter boxes were balanced and rotated between the same two locations at the end of each day to account for location bias in the test design. The average of weight deposits across products were used to determine acceptance or rejection of the fragrance.

### Dog Hedonics Testing

Tests were performed in order to determine if fragrance compositions were accepted or rejected by canines.

At least thirty-two trained dogs of mixed breeds and sex were monitored for their interaction with a fragrance oil dosed on an odorless support. The odorless support with tested fragrance/accord compositions Is presented to the dog in a monadic research design. Dog's spontaneous answer to the stimuli is captured with video recording and the following behaviours recorded: the sniffing latency time (the time it takes the dog to interact with the sample), length of time the animal directly smells the sample (sniffing time), if the dog licks the sample (negative behavioral outcome) and/or if the dog outright rejects the sample (does not approach to smell). The behaviors are coded and analyzed by skilled animal behaviorists. Two fragrance/accord compositions and a neutral control (typically water) are tested in a balanced and rotated design in each test.

The fragrances were presented to the cats and dogs at intensities that were similar according to human nose.

### Explanation of the Graphics

### For Cats

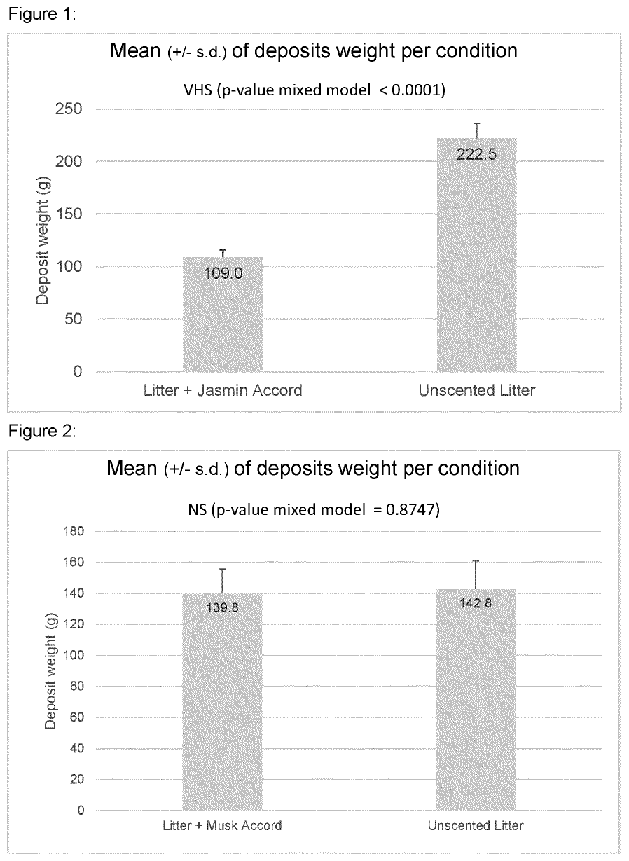

A very highly difference in a cat litter in terms of weight deposit looks like the graph in FIG. 1. For comparison, a not significant result looks like the graph in FIG. 2.

Silvervine is a known cat attractant and has been tested as the positive control. It has been dosed at 0.1% and 1% in the litter. No significant effect has been observed on the weight deposit.

In terms of behavior, cats explored more the litter with silvervine. This shows that they can perceive it (something is new, they come and discover it) but that it does not change their behavior elimination overall. They are not disturbed by the silvervine odor and use as much the scented litter as the unscented.

To compare the different fragrances, the log of the p-value has been reported on a graph. The bar above the horizontal axis is significant to very highly significant in favor of scented litter, the bar below the horizontal axis is significant to very highly significant in favor of the unscented litter. Samples in the white/bright section are not significant results and, thus, are as accepted by cats as unscented litter.

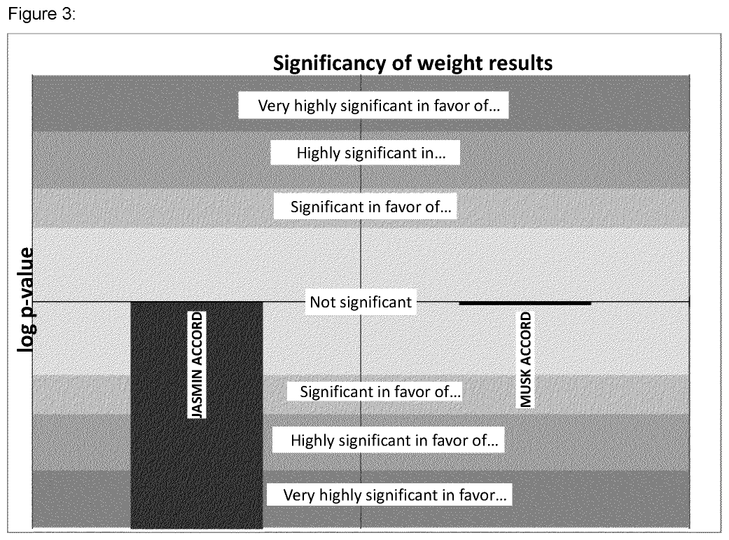

FIG. 3 represents an exemplary histogram showing the significancy of weight results in cat litter for jasmin accord (very highly significant in favor of unscented litter) and musk accord (not significant) in comparison. In the graph in FIG. 3, both fragrance/accord compositions were tested at 0.01%.

### For Dogs

Refusal was used as a key metric to determine acceptance/rejection of fragrance materials by dogs. A neutral odor was used in each test as a calibrant for dog motivation. Neutral sample is typically water.

Refusal is defined as follows:
(1) during a 15 second evaluation, the canine shows no interest in approaching the sample: or
(2) the canine approaches the sample and immediately turns away in 1 second or less.

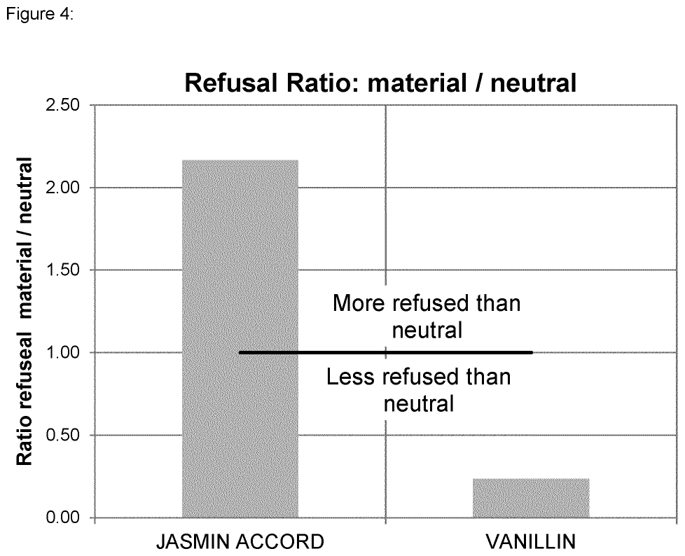

The representative example vanillin was well accepted and shows low refusal whereas the representative example jasmin shows high refusal, as it is shown in FIG. 4.

### 2. Overview of Cat Hedonic Results (Accepted Accords Versus Non Accepted Accords):

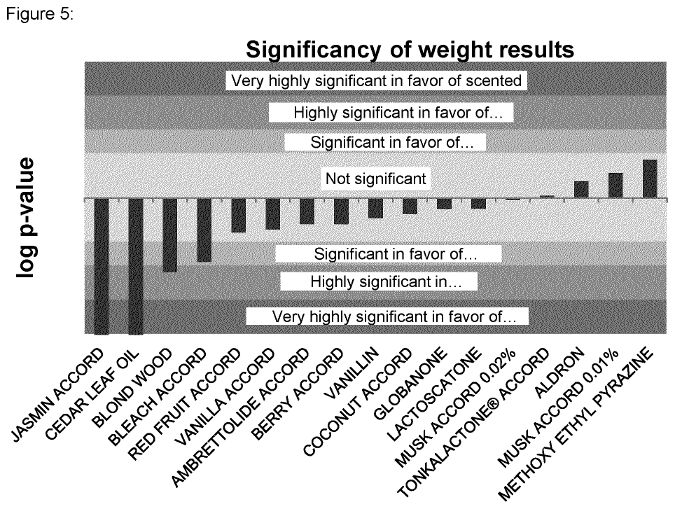

FIG. 5 is a histogram summarising the significancy of weight results in cat litter for accepted and non-accepted tested fragrance/accord compositions.

All of the accepted or preferred fragrances/accords on this graph resulting in more weight results in scented cat litter contain at least one of the following:
gourmand odor or gourmand notes (vanillin, Tonkalactone® accord, methoxy ethyl pyrazine), or
musk odor or musk notes (aldron, Globalide®, ethylene brassylate, lactoscatone).

The fragrances/accords on this graph that were not accepted and resulting in more weight results in unscented litter contain cedar leaf oil or orange flower. Also, blond wood and bleach accords were less accepted and result in more weight results in unscented litter.

The mean of deposits' weights per condition for the single fragrances/accords belonging to the gourmand odor type or gourmand note type are given in the following Table 4:

TABLE 4

| | Average weight in g | Average Weight in g | |
|---|---|---|---|
| Gourmand accords/ | (2 days test) | (2 days test) | P |
| materials tested | In scented Litter | in unscented litter | value |
| Methoxy ethyl pyrazine | 205.00 | 173.00 | 0.0774 |
| Red fruit accord | 164.50 | 193.00 | 0.0973 |
| Vanilla accord | 119.00 | 153.50 | 0.1213 |
| Vanillin | 142.00 | 169.50 | 0.2583 |
| Berry accord | 170.50 | 233.50 | 0.1718 |
| Coconut accord | 138.00 | 163.00 | 0.3404 |
| Tonkalactone ® accord | 185.50 | 182.50 | 0.8911 |

N = 10 (5 boxes * 2 days)

The mean of deposits' weights in methoxy ethyl pyrazine litter is not significantly different than in unscented litter.

The mean of deposits' weights in red fruit accord litter is not significantly different than in unscented litter.

The mean of deposits' weights in vanilla accord litter is not significantly different than in unscented litter.

The mean of deposits' weights in vanillin litter is not significantly different than in unscented litter.

The mean of deposits' weights in berry accord litter is not significantly different than in unscented litter.

The mean of deposits' weights in coconut accord litter is not significantly different than in unscented litter.

The mean of deposits' weights in Tonkalactone® accord litter is not significantly different than in unscented litter.

The mean of deposits' weights per condition for the single fragrance/accord compositions belonging to the musk odor type or musk note type are given in the following Table 5:

TABLE 5

| | Average weight in g | Average weight in g | |
|---|---|---|---|
| Musk accords/ | (2 days test) | (2 days test) | P |
| materials tested | in scented litter | in unscented litter | value |
| Aldron | 125.50 | 101.00 | 0.3385 |
| Ambrettolide | 182.00 | 209.00 | 0.1716 |
| Lactoscatone | 97.00 | 110.50 | 0.4815 |
| Globanone | 136.00 | 144.00 | 0.4752 |
| Musk accord | 191.50 | 161.50 | 0.1892 |
| 0.01% test 1 | | | |
| Musk accord | 139.83 | 142.83 | 0.8747 |
| 0.02% | | | |
| Musk accord | 127.50 | 162.00 | 0.0935 |
| 0.01% test 2 | | | |
| Musk accord | 171.50 | 207.50 | 0.4181 |
| 0.01% in sodium | | | |
| bentonite base | | | |

N = 10 (5 boxes * 2 days)

The mean of deposits' weights in aldron litter is not significantly different than in unscented litter.

The mean of deposits' weights in ambrettolide litter is not significantly different than in unscented litter.

The mean of deposits' weights in lactoscatone litter is not significantly different than in unscented litter.

The mean of deposits' weights in globanone litter is not significantly different than in unscented litter.

The mean of deposits' weights in musk accord (0.01%) litter is not significantly different than in unscented litter.

The mean of deposits' weights in musk accord (0.02%) litter is not significantly different than in unscented litter. This demonstrates that intensity of musk has no effect.

The mean of deposits' weights in musk accord (0.01%) litter is not significantly different than in unscented litter. This demonstrates that the test is repeatable.

The mean of deposits' weights in musk accord (0.01%) litter is not significantly different than in unscented litter (mean of deposits weight per condition for musk accord (0.1%) in a different litter base (sodium bentonite instead of chalk)). This demonstrates that a different litter base has no effect on the result (reproducibility).

The results of Table 1 relating to the gourmand odor type materials and the results of Table 2 relating to the musk odor type materials showing no preference in weight deposits versus the unfragranced cat litter, clearly demonstrate that such fragrance/accord materials are well accepted by cats.

The mean of deposits' weights per condition for the single fragrance/accord compositions belonging to the woody odor type or woody note type are given in the following Table 6:

TABLE 6

| | Average weight in g | Average weight in g | |
|---|---|---|---|
| Woody accords/ | (2 days test) | (2 days test) | P |
| materials tested | in scented litter | in unscented litter | value |
| Cedar leaf oil | 109.00 | 262.00 | 0.0001 |
| Bleach accord | 132.00 | 185.00 | 0.0134 |
| Blond wood | 195.00 | 277.83 | 0.0068 |
| Jasmin accord | 109.00 | 222.50 | 0.0001 |

N = 10 (5 boxes * 2 days)

The mean of deposits' weights in cedar leaf oil litter is significantly different than in unscented litter.

The mean of deposits' weights in bleach accord litter is significantly different than in unscented litter.

The mean of deposits' weights in blond wood litter is significantly different than in unscented litter.

The mean of deposits' weights in jasmine accord litter is significantly different than in unscented litter.

The results of Table 3 clearly demonstrate that the woody odor type accords are repulsive materials that are less accepted and, thus, rejected by cats.

### Overview of Dog Hedonic Results (Accepted Accords):

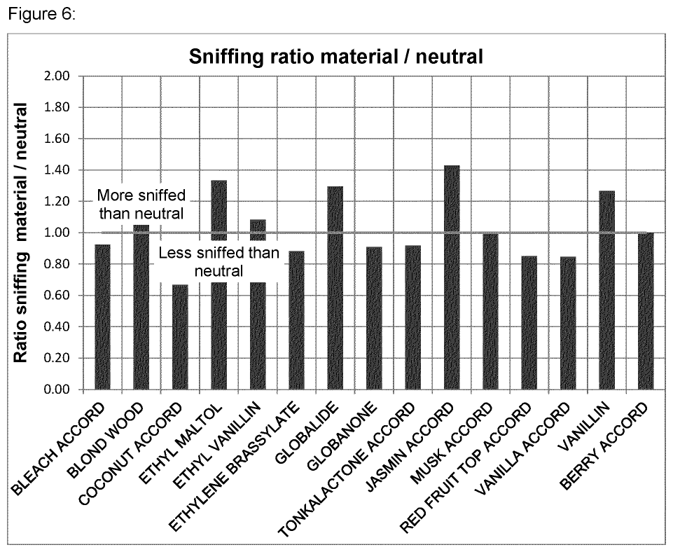

FIG. 6 shows fragrance/accord examples from the testing with dogs.

All fragrance/accord examples shown demonstrate low refusal ratios compared to the neutral odor (water) and are therefore well-accepted by dogs. The bars of the tested fragrance examples above the value of neutral odor (water) are considered very well accepted/preferred by dogs (e.g. ethyl maltol, globalide, vanillin, ethyl vanillin).

### Example 2—Fragrance/Accord Compositions that were Accepted

### Example 2.1—Fragrance/Accord Compositions of the Gourmand Odor Type

TABLE 7

| | | Concentration |
|---|---|---|
| Com- | | of raw material |
| position | Raw material | (%) |
| 1 | Vanillin | |
| | Vanillin | 45.00 |
| | Augeo clean multi | 55.00 |
| 2 | Methoxy ethyl pyrazine | |
| | Methoxy ethyl pyrazine | 100.00 |
| 3 | Vanilla accord | |
| | Ethyl maltol | 3.00 |
| | Heliotropin | 1.50 |
| | Vanillin | 10.00 |
| | Augeo clean multi | 85.50 |
| 4 | Tonkalactone accord | |
| | Furaminton/Tonkalactone ® | 10.00 |
| | (10% DPG) | |
| | Vanillin (10% DPG) | 90.00 |
| 5 | Coconut accord | |
| | Dipropylene glycol | 32.50 |
| | Vanillin (10% DPG) | 1.50 |
| | Decalactone delta | 14.00 |
| | Nonalactone delta | 26.00 |
| | Octalactone gamma | 26.00 |
| 6 | Berry accord | |
| | Ethyl methylphenylglycidate | 11.00 |
| | Ethyl maltol | 5.00 |
| | Frambinon ® | 10.00 |
| | Dipropylene Glycol | 54.00 |
| | Ethyl methyl butyrate-2 | 20.00 |
| 7 | Red fruit accord | |
| | Aldehyde C16 | 22.50 |
| | Ethyl maltol (10% DPG) | 3.75 |
| | Ethyl isobutyrate | 0.25 |
| | Frambinon ® (10% DPG) | 3.75 |
| | Dipropylene Glycol | 67.75 |
| | Ethyl methyl butylrate-2 | 1.75 |

### Example 2.2—Fragrance/Accord Compositions of the Musk Odor Type

TABLE 8

| | | Concentration |
|---|---|---|
| | | of raw material |
| Composition | Raw material | (%) |
| 1 | Aldron | |
| | Aldron | 1.00 |
| | Dipropylene glycol | 99.00 |
| 2 | Lactoscatone | |
| | Lactoscatone | 100.00 |
| 3 | Ambrettolide | |
| | Ambrettolide | 100.00 |
| 4 | Musk accord | |
| | Globalide | 10.00 |
| | Ethylene brassylate | 90.00 |
| 5 | Globanone | |
| | Globanone | 100.00 |

### Example 3—Fragrance/Accord Compositions that were not Accepted

TABLE 9

| | | Concentration |
|---|---|---|
| | | of raw material |
| Composition | Raw material | (%) |
| 1 | Cedar leaf oil | |
| | Cedar leaf oil | 100.00 |
| 2 | Blonde woods | |
| | Amberwood ® F | 14.29 |
| | Cedarwood oil | 2.86 |
| | Iso E super | 71.43 |
| | Sandranol ® | 11.43 |
| 3 | Jasmin accord | |
| | Benzyl acetate | 14.29 |
| | Dihydro jasmone | 0.71 |
| | Hedione | 53.57 |
| | Hexyl cinnamic | 28.57 |
| | aldehyde alpha | |
| | Indole 1% TEA | 2.86 |

1. A pet fragrance composition or pet aroma/flavour composition comprising at least one compound or lead sensory component of
group (A) consisting of compounds selected from the group consisting of
vanillin (4-hydroxy-3-methoxybenzaldehyde),
ethyl vanillin (3-ethoxy-4-hydroxybenzaldehyde),
ethyl maltol (2-ethyl-3-hydroxy-4H-pyran-4-one),
coumarin (2H-1-benzopyran-2-one),
Tonkalactone® (3,6-dimethyl-3H-1-benzofuran-2-one),
Frambinon® (4-(p-methoxyphenyl)-2-butanone),
benzaldehyde,
ethyl-2-methyl butyrate,
2-methoxy-3-ethyl pyrazine,
delta-decalactone, delta-nonalactone, gamma-octalactone,
and mixtures thereof;
and/or
group (B) consisting of compounds selected from the group consisting of
aldron (4-[(6,6-dimethyl-5-bicyclo[2.2.1]heptanyl)methyl]-2-methylcyclohexan-1-one),
lactoscatone ((2R,4aR,8aS)-2,8,8-trimethyloctahydro-2H-4a,2-(epoxymethano)naphthalen-10-one),
ambrettolide (17-oxacycloheptadec-6-en-1-one),
ethylene brassylate (1,4-dioxacycloheptadecane-5,17-dione),
Globalide ((3E)-oxacyclohexadec-3-en-2-one),
globanone ((8E)-cyclohexadec-8-en-1-one),
and mixtures thereof.

2. The pet fragrance composition or pet aroma/flavour composition according to claim 1, wherein the fragrance or aroma/flavour composition comprises
vanillin (4-hydroxy-3-methoxybenzaldehyde), or
Tonkalactone® (3,6-dimethyl-3H-1-benzofuran-2-one),
or a mixture thereof; or
wherein the fragrance or aroma/flavour composition comprises
ambrettolide (17-oxacycloheptadec-6-en-1-one),
Globalide® ((3E)-oxacyclohexadec-3-en-2-one),
globanone ((8E)-cyclohexadec-8-en-1-one), or
or a mixture of two or three of the afore-mentioned compounds.

3. The pet fragrance composition or pet aroma/flavour composition according to claim 1, wherein the fragrance or aroma/flavour composition comprises
vanillin (4-hydroxy-3-methoxybenzaldehyde),
Tonkalactone® (3,6-dimethyl-3H-1-benzofuran-2-one),
Globalide® ((3E)-oxacyclohexadec-3-en-2-one), or
ethylene brassylate (1,4-dioxacycloheptadecane-5,17-dione),
or mixtures thereof.

4. The pet fragrance composition or pet aroma/flavour composition; according to claim 1, wherein the at least one compound or the lead sensory component is present in a total amount in a range of 1 to 100% by weight based on the total weight of the composition.

5. The pet fragrance composition or pet aroma/flavour composition; according to claim 1, further comprising one or more additional fragrance substances selected from the group consisting of
methyl octine carbonate (methyl-non-2-ynoate),
phenyl ethyl alcohol (2-phenylethan-1-ol),
citronellol (3,7-dimethyloct-6-en-1-ol),
lavender oil,
peppermint oil,
and mixtures thereof.

6. The pet fragrance composition or pet aroma/flavour composition according to claim 1, further comprising one or more additional fragrance substances selected from the group consisting of
orange oil,
Litsea cubeba oil,
mandarin aldehyde (trans-2-dodecenal),
agrunitril (3,7-dimethyloct-6-enenitrile),
citral (3,7-dimethyl-2,6-octadienal),
and mixtures thereof.

7. (canceled)

8. The pet fragrance composition or pet aroma/flavour composition according to claim 1, wherein the fragrance composition is suitable to please and/or be accepted by cats and/or dogs.

9. A method of preparing a perfumed or flavored pet product, comprising formulating the product with the pet fragrance composition or pet aroma/flavour composition according to claim 1.

10. A perfumed pet product comprising the pet fragrance composition according to claim 1.

11. The perfumed pet product according to claim 10, wherein the product is selected from the group consisting of personal or home care products, surface care products, cleaning products, air care products, fabric products, auto care products, pet products, cat litter boxes, cat toys, cat trees, dog toys, dog pads, dog beddings, and pet care grooming or oral care products.

12. A flavored product comprising the pet aroma/flavour composition, according to claim 1.

13. The flavored product according to claim 12, wherein the product is selected from the group consisting of treats, breath and oral care products.

14. The perfumed product according to claim 10, wherein pet fragrance composition is present in a total amount in a range of 0.001 to 70% by weight, based on the total weight of the perfumed product.

15. A method for scenting a pet, a product or a room, comprising the steps of:
(i) providing a fragrance composition according to claim 1, or a perfumed pet product comprising the fragrance composition of claim 1; and
(ii) applying the fragrance composition or the perfumed pet product in a sensory effective amount to the pet, the product or the room to obtain an odor accepted by pets.

16. The method according to claim 15, wherein the pet is a mammal.

17. The method according to claim 16, wherein the pet is a dog or a cat.

18. The pet fragrance composition or pet aroma/flavour composition according claim 4, wherein the at least one compound or the lead sensory component is present in a total amount in a range of 40 to 50% by weight based on the total weight of the composition.

19. The perfumed product according to claim 14 wherein the pet fragrance composition is present in a total amount in a range 0.1% to 50% by weight, based on the total weight of the perfumed product.

20. The flavored product according to claim 12, wherein the aroma/flavour composition is present in a total amount in a range of 0.001 to 70% by weight, based on the total weight of the perfumed or flavored product.

21. The flavored product according to claim 20, wherein the aroma/flavour composition is present in a total amount in a range of 0.1% to 50% by weight, based on the total weight of the perfumed product.
